(19) United States
(12) Patent Application Publication
(10) Pub. No.: US 2011/0282515 A1
(43) Pub. Date: Nov. 17, 2011

(54) ZONE SHUT-DOWN CONTROL SYSTEM

(76) Inventor: Troy Michael DeFelice, Schriever, LA (US)

(21) Appl. No.: 13/108,462

(22) Filed: May 16, 2011

Related U.S. Application Data
(60) Provisional application No. 61/345,072, filed on May 15, 2010.

(51) Int. Cl. G05D 16/20

(52) U.S. Cl. 700/301

(57) ABSTRACT

A reconfigurable zone shut-down control system usable in an enclosure is provided, the system including: a field controller disposable within the enclosure; a control panel electrically connected to the field controller and disposable on the enclosure; a differential pressure switch electrically connected to the field controller; gas detectors electrically connected to the field controller; and a plurality of device controllers electrically connected to the field controller, wherein the plurality of device controllers includes a fresh air blower controller, a welding machine controller, an air compressor controller, or a gas torch controller.

### CROSS-REFERENCE TO RELATED APPLICATION

This application claims priority under 35 USC 119 to U.S. Provisional Patent Application No. 61/345,072, filed on May 15, 2010 and entitled “Zone Shut-Down Control System”, which is incorporated by reference herein in its entirety.

### BACKGROUND

The present disclosure generally relates to control systems, and more particularly relates to a hard-wired zone shut-down control system applicable to both on-shore and off-shore fossil fuel facilities.

When hot-work such as welding, torch cutting, grinding or the like was previously performed on oil or gas facilities in areas with the potential to release hydrocarbons or where the containment of sparks presented additional concerns, the facilities often shut down production equipment completely or re-routed the process for the duration of the work to assure safety. Such production interruptions typically resulted in lost revenue, logistical problems, and rushed turn-arounds that sometimes resulted in injuries.

When oil prices were lower, the cost to shut down production to perform hot-work in classified areas required a lot of planning, yet was generally considered affordable. Now that oil prices are higher, oil producers are increasingly concerned with lost or delayed production due to hot-work operations and shut-in time.

Safety is now recognized as the most important consideration in the oil industry. It is likely only a matter of time before requirements for enclosures and shut-down systems are implemented around the world for all hot-work performed at a fossil fuel facility. At the present time, the places in the world where it is already an industry requirement to use enclosures with shut-down systems include waters under the U.S. Mineral Management Service's (MMS) jurisdiction; and Europe (Europe Health and Safety). Law makers and Governments around the world are looking at implementing new safety requirements, providing a safer work place for people.

Pressurized enclosures and atmospheric monitoring and control systems present a new way to solve an old problem, allowing hot work within proximity to vessels, tanks and piping that can release hydrocarbons without warning

### SUMMARY

The present disclosure teaches zone shut-down control systems. Exemplary embodiments are provided.

An exemplary embodiment zone shut-down control system usable in an enclosure is provided, the system including: a field controller disposable within the enclosure; a control panel electrically connected to the field controller and disposable on the enclosure; a differential pressure switch electrically connected to the field controller for detecting a positive pressure differential inside the enclosure versus outside; gas detectors electrically connected to the field controller for detecting at least two of the following: hydrocarbons, oxygen, or toxic gas; and a plurality of device controllers electrically connected to the field controller, wherein the plurality of device controllers includes a fresh air blower controller, a welding machine controller, an air compressor controller, or a gas torch controller.

An exemplary embodiment reconfigurable zone shut-down control system usable in an enclosure is provided, the system comprising: a field controller disposed within the enclosure; a control panel electrically connected to the field controller; a differential pressure switch electrically connected to the field controller for detecting a positive pressure differential inside the enclosure versus outside; detectors electrically connected to the field controller for detecting at least two of the following: hydrocarbons, oxygen, or toxic gas; and a plurality of device controllers electrically connected to the field controller, wherein the plurality of device controllers includes at least one of a fresh air blower controller, a welding machine controller, an air compressor controller, or a gas torch controller.

A further exemplary embodiment zone shut-down control system is provided, wherein the field controller is disposed to shut down all devices connected to the plurality of device controllers in accordance with a signal from the control panel.

A further exemplary embodiment zone shut-down control system is provided, wherein the field controller is disposed to shut down at least one device connected to the plurality of device controllers if the differential pressure switch fails to detect a positive pressure differential inside the enclosure versus outside.

A further exemplary embodiment zone shut-down control system is provided, wherein the field controller is disposed to simultaneously shut down a plurality of devices connected to the plurality of device controllers if the differential pressure switch fails to detect a positive pressure differential inside the enclosure versus outside.

A further exemplary embodiment zone shut-down control system is provided, wherein the field controller is disposed to sequentially shut down in a pre-defined order a plurality of devices connected to the plurality of device controllers if the differential pressure switch fails to detect a positive pressure differential inside the enclosure versus outside.

A further exemplary embodiment zone shut-down control system is provided, further comprising: an external fresh air blower connected to the fresh air blower controller; and an external gas detector disposed in the air intake path of the fresh air blower and connected to the fresh air blower controller, wherein the field controller is configured to shut down at least one device if the external gas detector detects at least one of a toxic or flammable gas.

A further exemplary embodiment zone shut-down control system is provided, wherein the control panel is disposed on a wall of the enclosure, and all system components are explosion-proof (EX) rated.

A further exemplary embodiment zone shut-down control system is provided, wherein at least one source of flammable gas is disposed outside of the enclosure.

Another exemplary embodiment zone shut-down control system usable in an enclosure is provided, the system comprising: field control means disposable within the enclosure; input/output means connected to the control means; differential pressure means connected to the control means; gas detection means connected to the control means; and device control means connected to the field control means, wherein the device control means includes at least one of fresh air blower control means, welding machine control means, air compressor control means, or gas torch control means.

A further exemplary embodiment zone shut-down control system is provided, wherein the field control means is disposed to shut down all devices connected to the plurality of device control means in accordance with a signal from the input/output means.

A further exemplary embodiment zone shut-down control system is provided, wherein the field control means is disposed to shut down at least one device connected to the device control means if the differential pressure means fails to detect a positive pressure differential inside the enclosure versus outside.

A further exemplary embodiment zone shut-down control system is provided, wherein the field control means is disposed to simultaneously shut down a plurality of devices connected to the device control means if the differential pressure means fails to detect a positive pressure differential inside the enclosure versus outside.

A further exemplary embodiment zone shut-down control system is provided, wherein the field control means is disposed to sequentially shut down in a pre-defined order a plurality of devices connected to the device control means if the differential pressure means fails to detect a positive pressure differential inside the enclosure versus outside.

A further exemplary embodiment zone shut-down control system is provided, further comprising: an external fresh air blower connected to the fresh air blower control means; and an external gas detector disposed in the air intake path of the fresh air blower and connected to the fresh air blower control means, wherein the field control means is configured to shut down at least one device if the external gas detector detects at least one of a toxic or flammable gas.

An exemplary embodiment method of zone monitoring and control is provided, comprising: sensing flammable and toxic gas contaminants in air; if flammable or toxic gas contaminants are sensed, signaling an alarm; if flammable or toxic gas contaminants are not sensed, passing electrical power and gas to equipment within the zone; and if an emergency shutdown switch is activated in the zone, preventing power and gas from reaching equipment within the enclosure.

A further exemplary embodiment method of zone monitoring and control is provided, wherein the equipment includes electrical and gas tools comprising at least one of a fresh air blower, a welding machine, an air compressor, or a gas torch.

A further exemplary embodiment method of zone monitoring and control is provided, said contaminants comprising at least two of hydrocarbons, oxygen, or toxic gas.

A further exemplary embodiment method of zone monitoring and control is provided, wherein at least one source of flammable gas is disposed outside of the zone.

A further exemplary embodiment method of zone monitoring and control is provided, wherein the zone is a temporary enclosure, the method further comprising: sensing flammable or toxic gas contaminants in intake air; if no contaminants are sensed, blowing the intake air into the enclosure; sensing flammable or toxic gas contaminants in the enclosure; and if no contaminants are sensed, providing power and gas to equipment within the enclosure.

A further exemplary embodiment method of zone monitoring and control is provided, further comprising: sensing a positive pressure differential between air inside the enclosure relative to air outside the enclosure; and if a positive pressure differential is not sensed, performing a shutdown of electrical and gas equipment within the enclosure.

### BRIEF DESCRIPTION OF THE DRAWINGS

The present disclosure provides zone shut-down control systems, where like reference numerals may refer to like elements in the following exemplary figures, in which:

FIG. 1 is a schematic block diagram showing a zone shut-down control system in accordance with an exemplary embodiment of the present disclosure;

FIG. 2 is a schematic block diagram showing a zone shut-down control system with an enclosure in accordance with an exemplary embodiment of the present disclosure;

FIG. 3 is a schematic diagram showing a zone shut-down control system in an open air zone in accordance with an exemplary embodiment of the present disclosure;

FIG. 4 is a schematic diagram showing a zone shut-down control system in a confined space or vessel in accordance with an exemplary embodiment of the present disclosure;

FIG. 5 is a schematic diagram showing a zone shut-down control system configured for monitoring toxic gas in accordance with an exemplary embodiment of the present disclosure;

FIG. 6 is a schematic diagram showing a zone shut-down control system configured for monitoring airborne hydrocarbons in accordance with an exemplary embodiment of the present disclosure;

FIG. 7 is a schematic diagram showing a zone shut-down control system having a torch controller in accordance with an exemplary embodiment of the present disclosure;

FIG. 8 is a schematic diagram showing a remote control unit in accordance with an exemplary embodiment of the present disclosure;

FIG. 9 is a schematic diagram showing a field control unit in accordance with an exemplary embodiment of the present disclosure;

FIG. 10 is a schematic diagram showing a gas detection unit in accordance with an exemplary embodiment of the present disclosure;

FIG. 11 is a schematic diagram showing a torch unit in accordance with an exemplary embodiment of the present disclosure;

FIG. 12 is a schematic diagram showing a welding control unit in accordance with an exemplary embodiment of the present disclosure;

FIG. 13 is a schematic diagram showing a compressor control unit in accordance with an exemplary embodiment of the present disclosure;

FIG. 14 is a schematic diagram showing a blower control unit in accordance with an exemplary embodiment of the present disclosure;

FIG. 15 is a schematic electrical diagram showing an explosion-proof (EX) rated zone shut-down control system in accordance with an exemplary embodiment of the present disclosure;

FIG. 16 is a schematic electrical diagram showing another zone shut-down control system in accordance with an exemplary embodiment of the present disclosure;

FIG. 17 is a schematic diagram showing a field control unit in accordance with an exemplary embodiment of the present disclosure;

FIG. 18 is a schematic electrical diagram showing a field control unit in accordance with an exemplary embodiment of the present disclosure;

FIG. 19 is a schematic diagram showing a remote control unit in accordance with an exemplary embodiment of the present disclosure;

FIG. 20 is a schematic electrical diagram showing a remote control unit in accordance with an exemplary embodiment of the present disclosure;

FIG. 21 is a schematic diagram showing a welding control unit in accordance with an exemplary embodiment of the present disclosure; and

FIG. 22 is a schematic electrical diagram showing a welding control unit in accordance with an exemplary embodiment of the present disclosure.

### DETAILED DESCRIPTION OF PREFERRED EMBODIMENTS

Exemplary embodiments of the present disclosure provide a hard-wired zone shut-down control system applicable to both on-shore and off-shore Oil and Gas facilities. The presently disclosed system monitors an environment and controls equipment to permit hot-work, such as welding, to be performed safely in an operating production area. The system is self-contained with no need for external wireless communications or remote operators. In preferred embodiments, the system is operated and monitored by a system tech located at the site hot work is to be performed Exemplary embodiment systems satisfy particular needs for shut-down systems using fail-safe modern components. Preferred embodiments use only explosion-proof (EX) rated components. In addition, the systems are user friendly, re-configurable, economical, and emphasize safety.

Exemplary embodiment zone shut-down control systems are described herein. The systems can work independently of an enclosure, or within one. Such an enclosure may be of the soft type and/or the hard type. If an optional pressurized enclosure is used, exemplary embodiment zone shut-down control systems can meet the standards set forth in 250 C.F.R. 803(b)(9)(i) for air flow and positive pressure control within such enclosures.

When hot-work needs to be done at an oil or gas facility, exemplary embodiment control systems may be employed to perform the work without shutting down production to the facility or nearby process equipment. The system is designed to work with hot-work pressurized enclosures or Habitats. The system is an automatic shut-down system that will shut down all associated hot-work equipment used in hot-work enclosures. This eliminates the possibility of human error in the critical seconds leading up to a potentially disastrous scenario that can occur during hot-work operations.

The automated field controller device may be used in pressurized hot work welding enclosures. These enclosures are used in areas that contain or may possibly contain combustible atmospheres or that may require spark containment to protect flammable/combustible material. This field controller devise automatically shuts down all associated equipment used in this enclosure. This is achieved by continually monitoring the atmosphere and pressure inside the enclosure. In the event of a gas detection and/or loss of pressure, the field controller devise will shut down the enclosure and all equipment use in the enclosure.

The system has three primary modes of operation. It may be used in pressurized welding enclosures with integrated equipment shut down capability, in an open air non-pressurized scenarios for hot work with integrated equipment shut down capability, and/or in open air monitoring for hazardous atmospheres.

Exemplary embodiment systems are hard-wired and require no wireless devices. The control panel is on site where the work is being performed, and is also rated explosion proof for classified areas. The system does not require any computer software to operate. The battery backup light is a self contained unit with the battery built into the light, and is explosion proof (EX) rated.

All system components use secure quick-disconnects or plugs to connect, so no permanent wiring is needed between components. A single system can be operated in three different scenarios, including 1) used in conjunction with a pressurized enclosure with integrated equipment shutdown capability; 2) used in a zone configuration that allows integrated equipment shutdown capability during open air hot work without any enclosure; and/or 3) open air monitoring that does not require integrated equipment shutdown.

Exemplary embodiment systems exceed the 13 currently mandated requirements of the United States Mineral Management Services (MMS) to perform hot work operations within 10 feet or 3 meters of production equipment without shutting down production. The systems continuously monitor the atmosphere inside the enclosure for hydrocarbons (e.g., 10% of LEL), oxygen levels (e.g., 19.5%-23.5%) and positive pressure (e.g., 50 Pascal).

Any gas detector alarm and/or loss of pressure will automatically shut down the enclosure and associated equipment such as welding machines, oxygen/acetylene cutting equipment and compressed air tools. In addition, a remote emergency shut-down switch (ESD) for integrated hot work components is provided for manual shutdown.

An exemplary embodiment system integrates all hot work equipment, provides continuous atmospheric monitoring, and permits the operator of the system to be located at the enclosure. Moreover, one system can be used in three configurations, such as 1) positive pressure enclosures, 2) non-pressure, no enclosure monitoring with equipment shutdown capability, and/or 3) open air atmospheric monitoring.

The system is compact and lightweight, quickly deployable, incorporates an explosion-proof operator control panel, features readily available up-to-date parts, and provides excellent economic value. The system is designed to be operated by one Technician. In addition, the system is easily modified to meet the complete needs of the client.

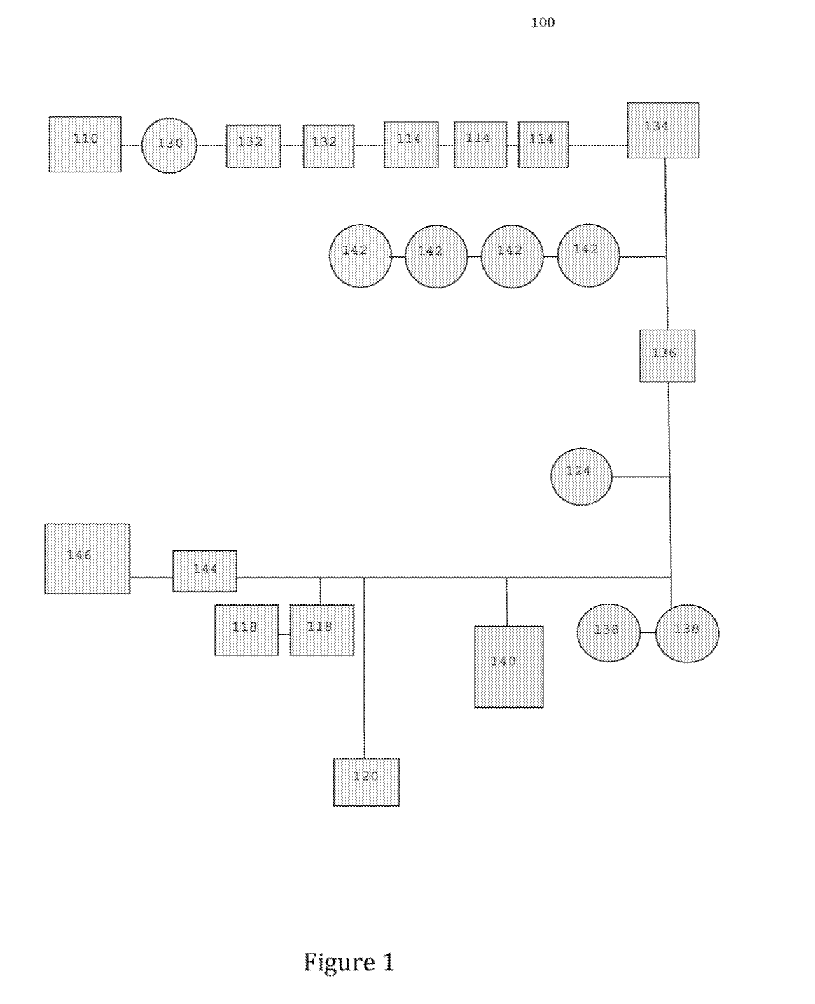

As shown in FIG. 1, an exemplary embodiment zone shut-down control system is indicated generally by the reference numeral 100. The system 100 includes a control panel 110, a differential pressure switch (DPS) 130 connected to the control panel, first and second emergency shutdown switches (ESD) 132 connected in series to the DPS, first, second and third gas detectors 114 connected in series to the second ESD, a main relay 134 connected to the third gas detector, four 220 Volt, 20 Amp receptacles 142 connected in series to the main relay, an auxiliary relay 136 connected to the main relay, and a blower controller 144 connected between the auxiliary relay and the control panel. A blower 146 is connected to the blower controller.

Two gas solenoids 138 are connected to the auxiliary relay. At least one work light 124 is also connected to the auxiliary relay. In addition, a welding controller 118, an air compressor controller 120, and a battery back-up 140 are each connected to the auxiliary relay. The battery back-up includes an integral emergency battery back-up light that can operate on 110/220 volts for normal operation and has a battery back-up which will engage when the power is shut off to the system allowing for emergency egress.

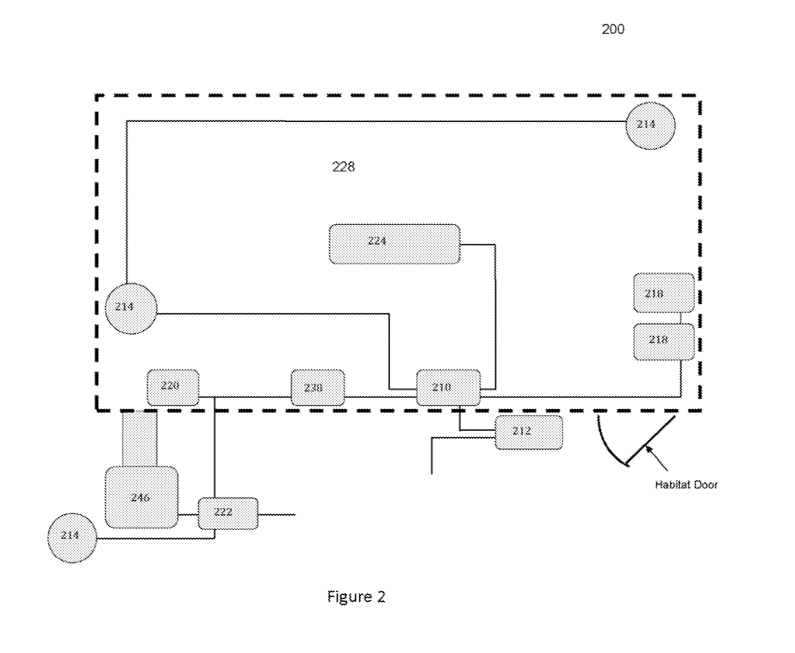

Turning to FIG. 2, another exemplary embodiment zone shut-down control system is indicated generally by the reference numeral 200. The system 200 includes an enclosure 228, which may be a hard and/or soft sided enclosure. A field controller 210 is disposed within the enclosure, and is powered by a main power line or supply.

A control panel 212, which is connected to the field controller by at least one multi-conductor cable, is preferably disposed adjacent to an enclosure door 226. Here, the control panel is placed on the outside of the enclosure, but may be placed inside the enclosure in alternate embodiments. Moreover, the control panel may be duplicated inside and outside of the enclosure, or placed in an optically transparent two-door chamber that is accessible from both inside and outside of the enclosure, such as in a wall or door of the enclosure.

The field controller is connected to a plurality of gas detectors 214, at least one of which is disposed within the enclosure. Each gas detector may be configured to detect a plurality of gases. Preferably, each gas detector is configured to detect the same two gas types, such as hydrocarbon vapors and oxygen (O2). Alternately, one or more of the gas detectors may be configured to detect toxic gas. The field controller is also connected to a welding machine controller 218, an air compressor controller 220, a blower controller 222, a work light 224, and a gas solenoid 238. The welding controller may have dual control inputs to safely switch two high current electrical outlets and/or at least one fuel outlet. The fuel outlet may be connected to various machines, such as, for example, a gas metal arc welding (e.g., MIG) machine, a gas tungsten arc welding (e.g., TIG) machine, a diesel-powered machine or a gasoline-powered machine.

In alternate embodiments, there may be four device controllers including a blower controller, welding equipment controller, compressed air controller, and gas torch controller. All of these devices are wired to the field controller. The field controller operates these devices by a series circuit. If there is an alarm from the gas detectors, the field controller will shut down all devices simultaneously. This is called a loop circuit. All of the devices are activated by a signal from the field controller and are shut down when the signal is lost due to a gas detector alarm or otherwise.

The blower controller 220, which may be located away from the enclosure, preferably receives external power from the same main power line or supply as the field controller. A fresh air blower is connected to the blower controller. At least one gas detector 214 is connected to the field controller and disposed at each inlet to the blower.

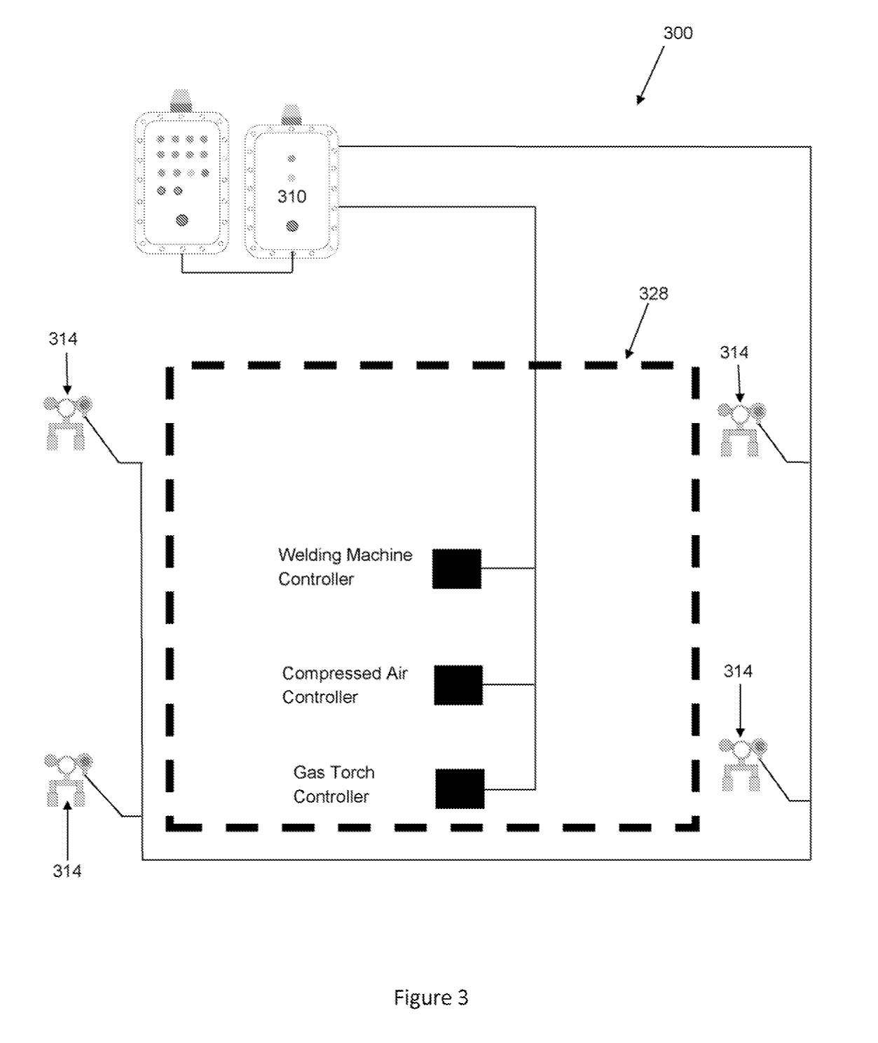

Turning now to FIG. 3, another exemplary embodiment zone shut-down control system is indicated generally by the reference numeral 300. The system 300 is similar to the system 200 of FIG. 2, so duplicate description may be omitted. The system 300 differs in that it defines an open air non-pressurized hot-work scenario, and does not require a hard or soft enclosure. Accordingly, the system 300 includes a field control box 310 connected in series and/or parallel to a plurality of gas detectors 314.

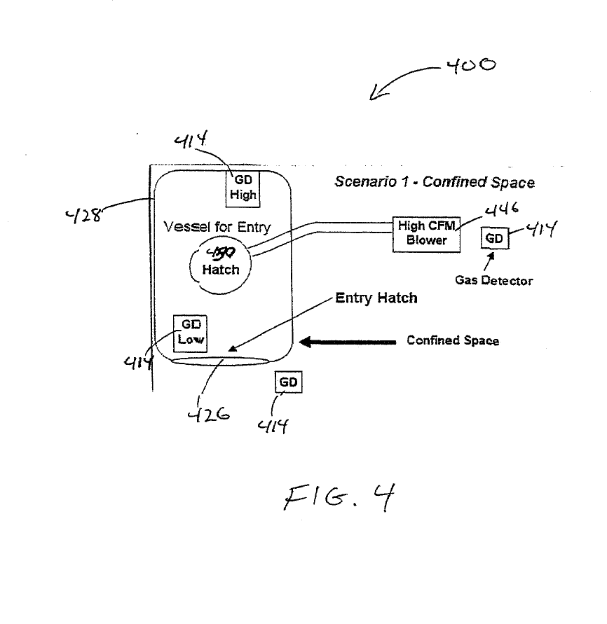

As shown in FIG. 4, another exemplary embodiment zone shut-down control system is indicated generally by the reference numeral 400. The system 400 is similar to the system 200 of FIG. 2, so duplicate description may be omitted.

The system 400 includes a confined space or vessel 428 having an entry hatch 426. Within the vessel, one gas detector 414 is mounted high near the top of the enclosure, and another gas detector 414 is mounted low near the bottom of the enclosure. In a preferred embodiment, the low-mounted gas detector may be configured to detect at least one heavier gas (e.g., hydrogen sulfide) than the high-mounted gas detector. Yet another gas detector 414 is mounted outside of the vessel at an inlet of a fresh air blower having a high cubic-foot-per-minute (CFM) output. The vessel further includes an air hatch 450 for receiving the high CFM output from the blower.

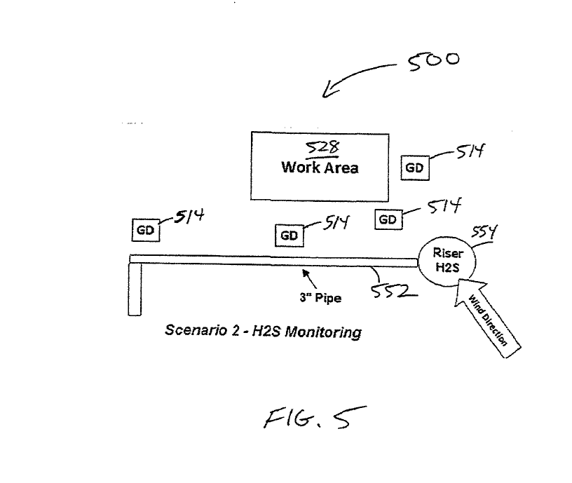

Turning to FIG. 5, another exemplary embodiment zone shut-down control system is indicated generally by the reference numeral 500. The system 500 is similar to the system 200 of FIG. 2, so duplicate description may be omitted.

The system 500 may be configured to monitoring for toxic gas, such as hydrogen sulfide (H2S). The system 500 includes a work area 558, a 3-inch pipe 552 having an H2S riser 554 disposed at one end, and a plurality of gas detectors 514 disposed between the H2S riser and the work area. These gas detectors may be configured to detect other toxic gases in addition to H2S. The gas detectors are preferably disposed in line with the current and anticipated wind directions across the H2S riser.

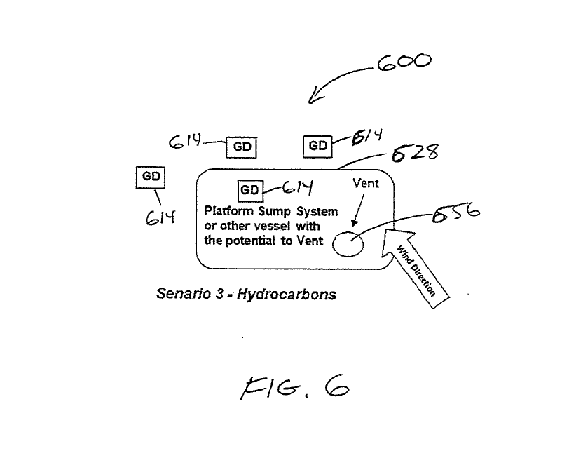

Turning now to FIG. 6, another exemplary embodiment zone shut-down control system is indicated generally by the reference numeral 600. The system 600 is similar to the system 200 of FIG. 2, so duplicate description may be omitted.

The system 600 may be configured for monitoring airborne hydrocarbons, for example. The system 600 includes a platform sump system 628 or other vessel with the potential to vent hydrocarbons, a vent 656 on the vessel, at least one gas detector 614 disposed at the vent, and a plurality of gas detectors 614 disposed between the vent and a work area. These gas detectors may be configured to detect at least hydrocarbon vapors. The gas detectors are preferably disposed in line with the current and anticipated wind directions across the hydrocarbon vent.

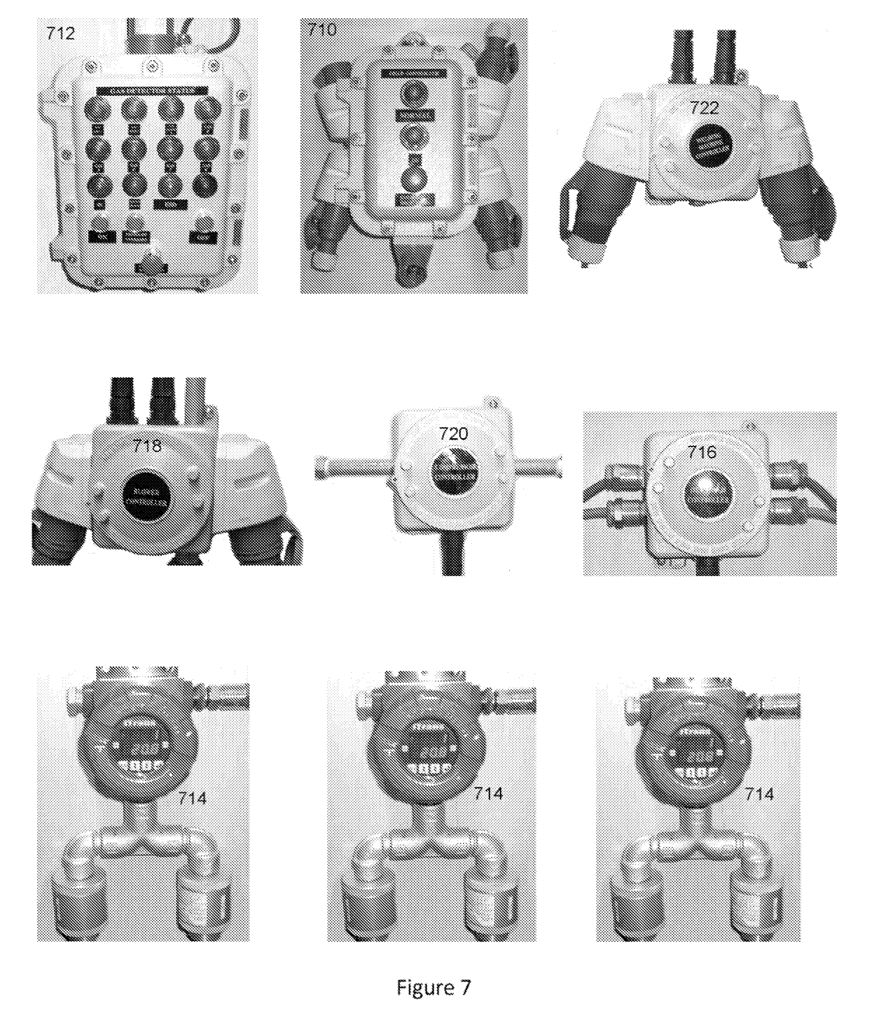

As shown in FIG. 7, another exemplary embodiment zone shut-down control system is indicated generally by the reference numeral 700. The system 700 is similar to the system 200 of FIG. 2, so duplicate description may be omitted. The system 700 includes a field controller 710, a remote panel unit 712, a plurality of gas detectors 714, each configured to detect at least two types of gases, and a plurality of device controllers. Here, the device controllers include a welding machine controller 718, an air compressor controller 720, a blower controller 722, and an oxy-acetylene or other dual-gas torch controller 716. The torch controller may have a single control input to control both gas lines and is connected to the field controller in the same manner as the other device controllers.

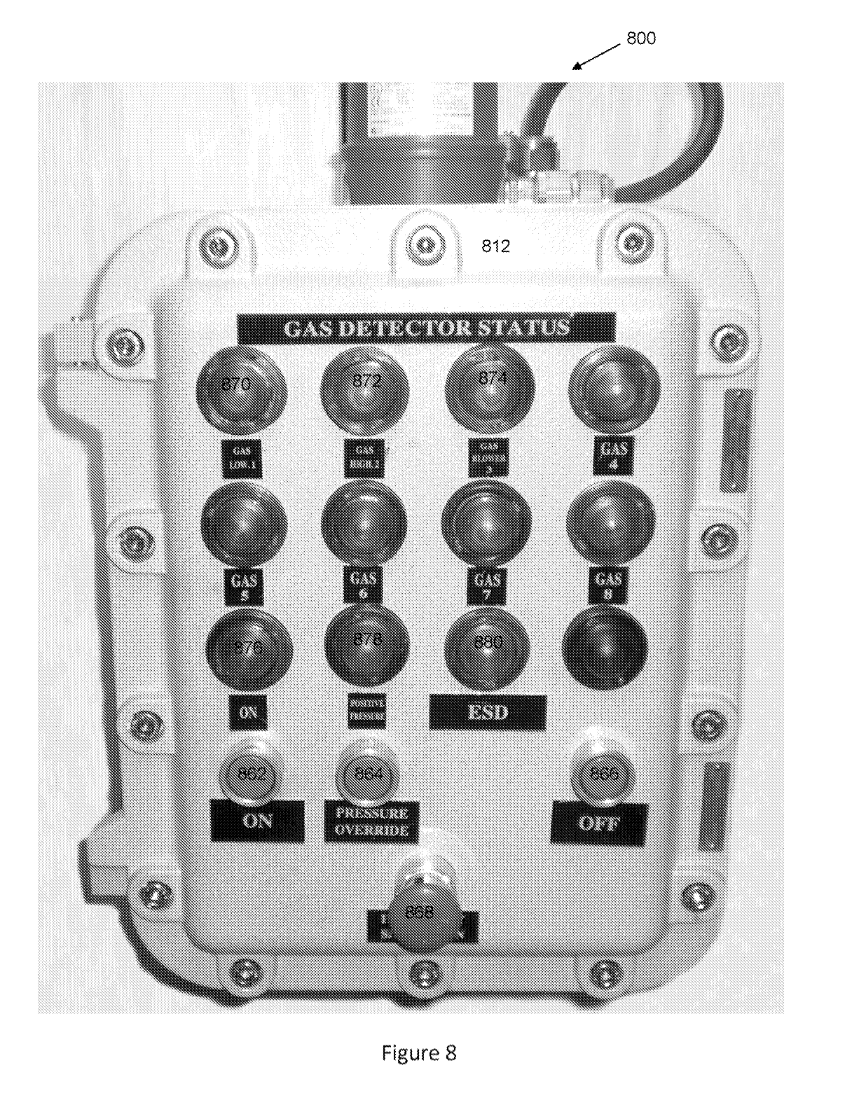

Turning to FIG. 8, a remote control unit is indicted generally by the reference numeral 800. The remote unit is similar to the remote controller 212 of FIG. 2, and may be hardwired to the field controller 210 of FIG. 2 from the outside of any enclosure.

The remote unit includes a control panel 812 having a plurality of switches and status lights. The panel includes a Remote Controller section having a green blower indicator light 874, a green high speed indicator 872, and a green low speed indicator 870. The panel further includes a Gas Detector Status section having a green “ON” indicator 876, a green “Positive Pressure” indicator 878, and a yellow “ESD” indicator 880. In addition, the panel has a switch section including a green “ON” button 862, a green “Pressure Override” button 864, a red “OFF” button 866, and an over-sized red Emergency Shut-Down button 868.

Here, the remote control unit 800 is an explosion proof rated controller, which is placed at the site of the work being done and is used by the operator to turn the system on and off. The controller typically has eight gas detector indicator lights that are illuminated during normal operations. In the event of a gas detector alarm, the corresponding lamp will turn off letting the operator know which gas detector has alarmed. The controller also has an emergency shutdown switch (ESD) that allows the operator to manually shut the system down. The controller is also equipped with an audio/visual alarm, and optionally a pressure override switch that allows temporary bypass of the blower gas detector and positive pressure indicator light. This controller is connected to the field control unit.

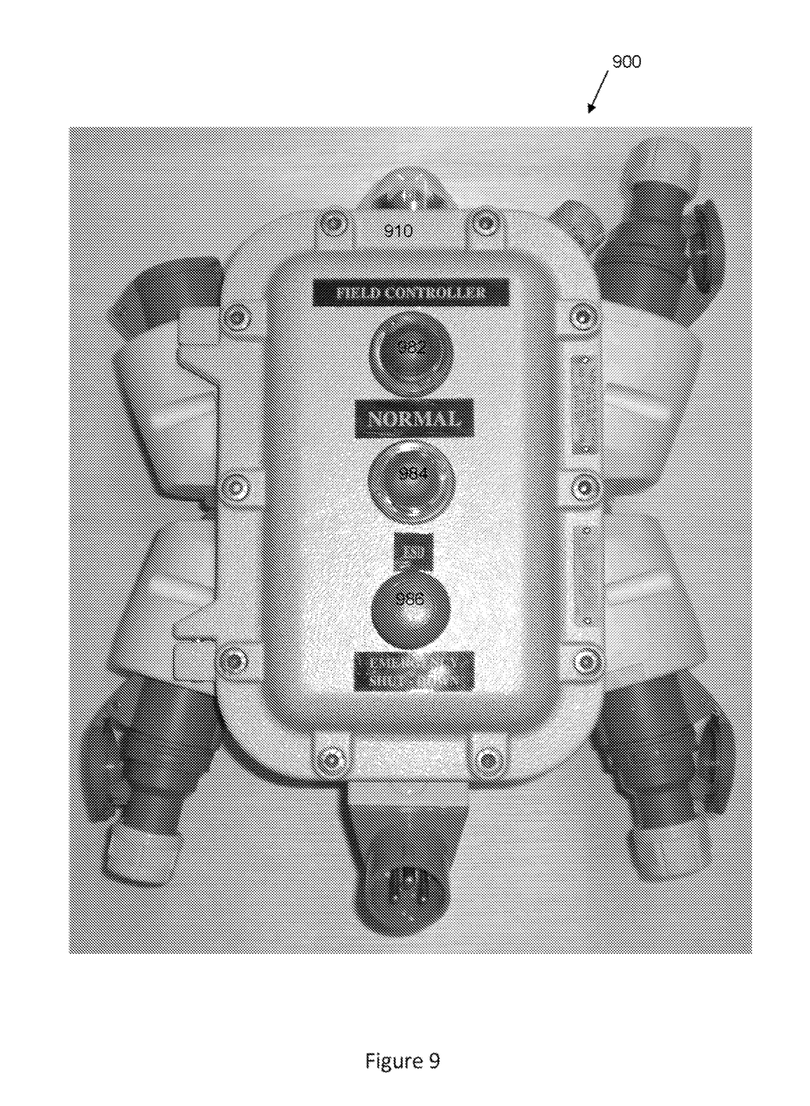

Turning now to FIG. 9, a field control unit is indicted generally by the reference numeral 900. The field unit includes a Field Controller 910 having a green Normal indicator 982, a yellow ESD indicator 984, and an over-sized red Emergency Shut-Down button 986.

In operation, the field control unit is responsible for controlling the equipment associated with the hot work operation and gas detectors. Here, the controller has an audio/visual alarm, normal operations indicator light, an ESD for manual shutdown and four ground fault protected outlets. The controller can also be connected to the facility ESD system. This controller is the central tie-in point for all the gas detectors and remote equipment or device controllers. This controller also uses a differential pressure switch (DPS) to monitor the atmospheric pressure for 50 Pascal of positive pressure. Loss of pressure will shut down the system. The DPS can be turned off so that the system can operate in a non-pressurized environment.

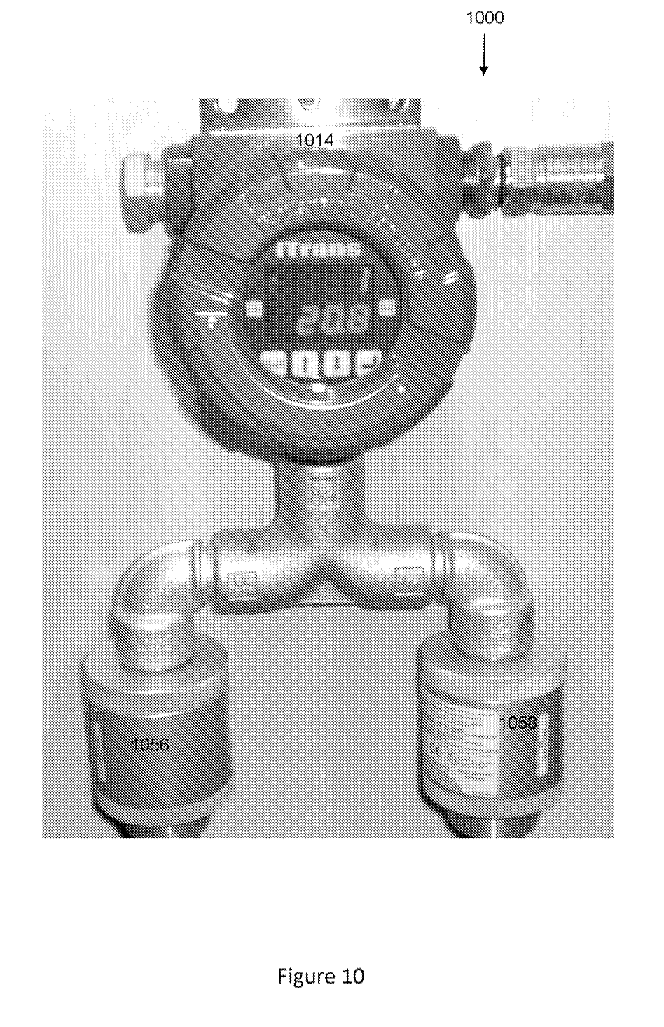

As shown in FIG. 10, a gas detection unit is indicted generally by the reference numeral 1000. The unit 1000 includes a gas detector 1014, a first gas type adapter 1056 connected to the detector, and a second gas type adapter 1058 connected to the detector. The gas type adapters 1056 or 1058 may be configured to detect hydrocarbon vapors, oxygen levels, and/or toxic gases, for example. Thus, the gas detection unit 1014 with two gas type adapters is capable of detecting two different types of gases substantially simultaneously.

The gas detectors may all be the same type. They may be dual channel multi-type detectors. They can be configured for any two combinations of the following: Hydrocarbons, oxygen (O2), and/or toxic gas. For the exemplary embodiment system, they are set up for hydrocarbons and O2 detection. Any alarm from any detector will shut down the system by a contactor in the detector. Data from the detectors is available on the gas detector units or at a remote device.

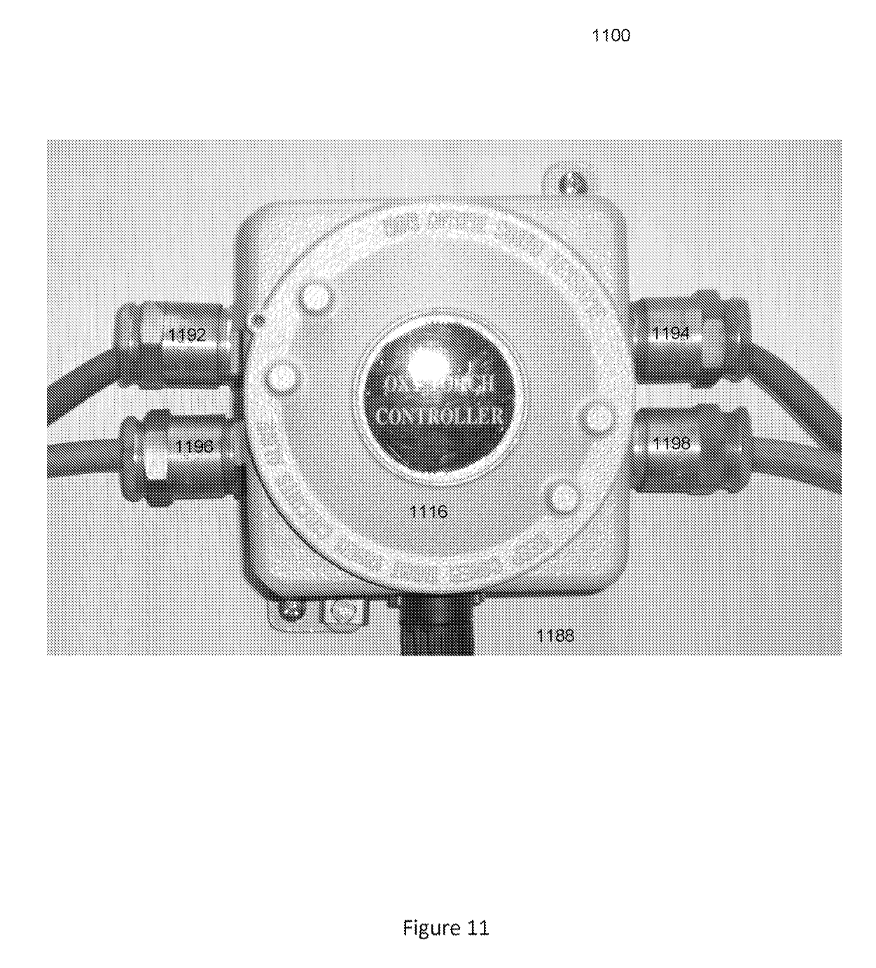

Turning to FIG. 11, a torch unit is indicated generally by the reference numeral 1100. The torch unit includes a torch controller 1116 includes a control signal input 1188, a first gas inlet 1192, a first gas outlet 1194, a second gas inlet 1196, and a second gas outlet 1198. The torch controller passes both the first and second gas lines when receiving an active control signal on the signal input 1188, but blocks both the first and second gas lines when a loss of control signal is detected.

In operation, the torch or cutting gas controller is used to shut off the cutting gas supply by using two inline electric solenoids of the normally closed position design to fail safe. This controller is wired to the field control unit

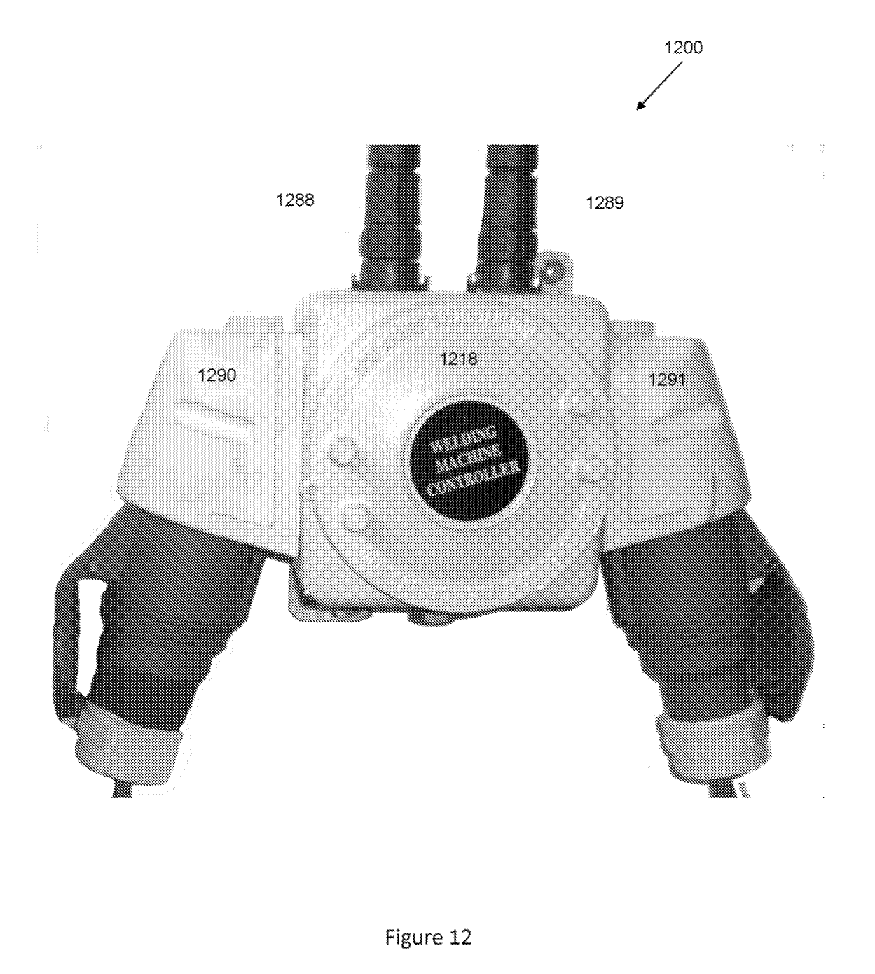

Turning now to FIG. 12, a welding control unit is indicated generally by the reference numeral 1200. The welding unit 1200 includes a welding machine controller 1218 having a first control signal input 1288, a second control signal input 1289, a first switched output 1290, and a second switched output 1291. The first switched output is controlled by the first control signal input, and the second controlled output is controlled by the second control signal input. The first and second controlled outputs are shown as electrical outputs here, but at least one may include a gas outlet in an alternate embodiment.

The welding equipment controller is used to shut down welding equipment using a normally closed electric contactor design to fail safe. This controller can be tied in to electric and/or fuel-powered equipment. This controller is wired to the field control unit

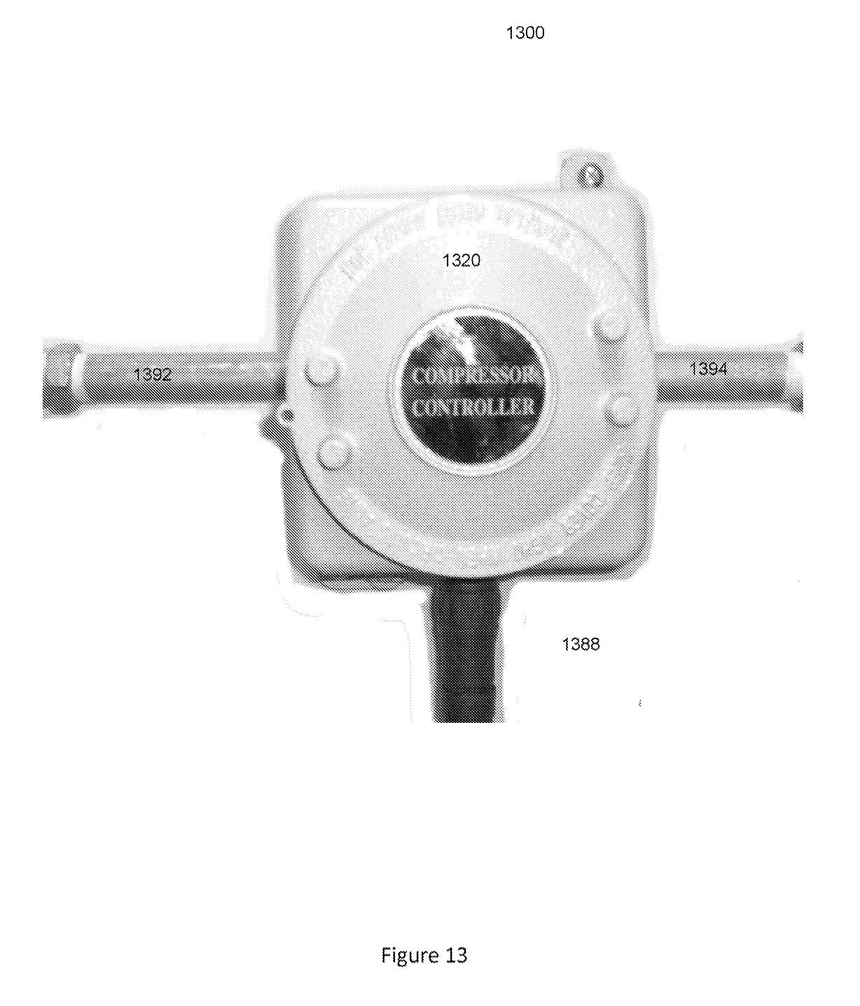

As shown in FIG. 13, a compressor control unit is indicated generally by the reference numeral 1300. The unit 1300 includes a compressor controller 1320 having a control signal input 1388, a compressed air inlet 1392, and a compressed air outlet 1394.

The compressed air controller is used to shut off the compressed air supply using an inline electric solenoid of the normally closed position design to fail safe. This controller is wired to the field control unit

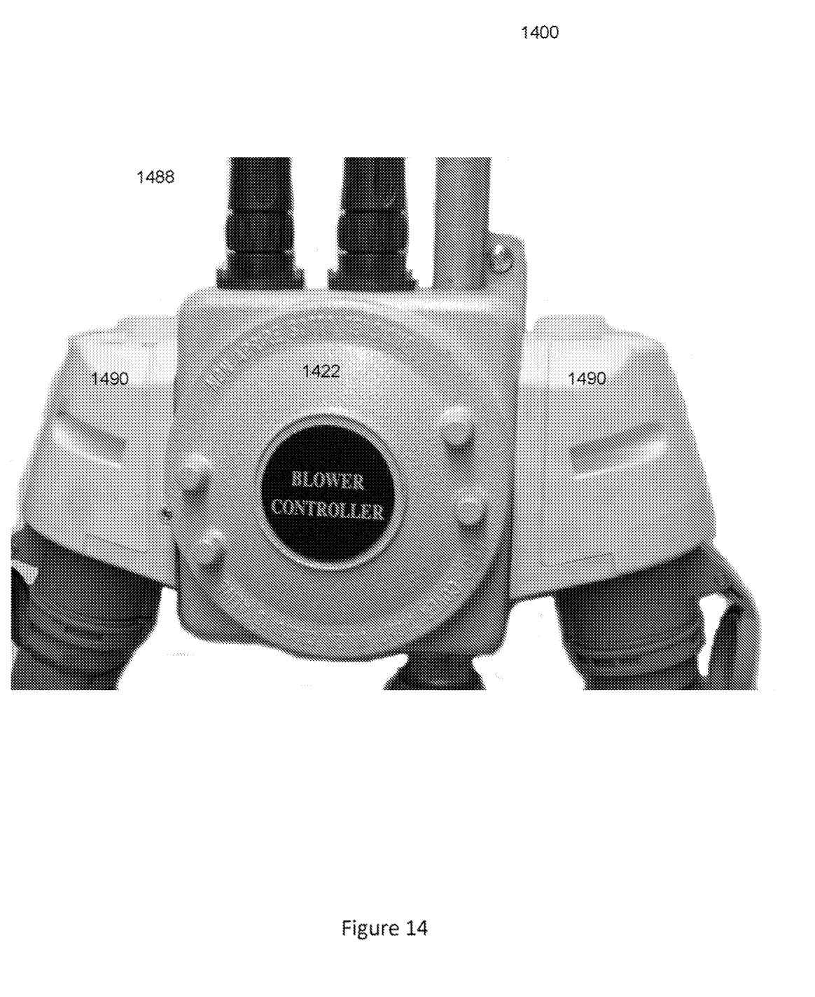

Turning to FIG. 14, a blower control unit is indicated generally by the reference numeral 1400. The unit 1400 includes a blower controller 1422 having at least one control signal input 1488 and at least one electrical outlet 1490. The blower controller may further include a local gas detector and/or a local gas detector signal input.

The blower controller is used to shut off the fresh air supply that is used to pressurize an enclosure. This controller can be tied in to an electric or air driven blower or fan. This controller is operated by the use of a gas detector in series with an electric contactor and/or electric solenoid. The contactor is normally open and the solenoid is normally closed to fail safe. This controller does not operate without a positive input from the gas detector or the positive pressure override switch. This controller is wired to the field control unit.

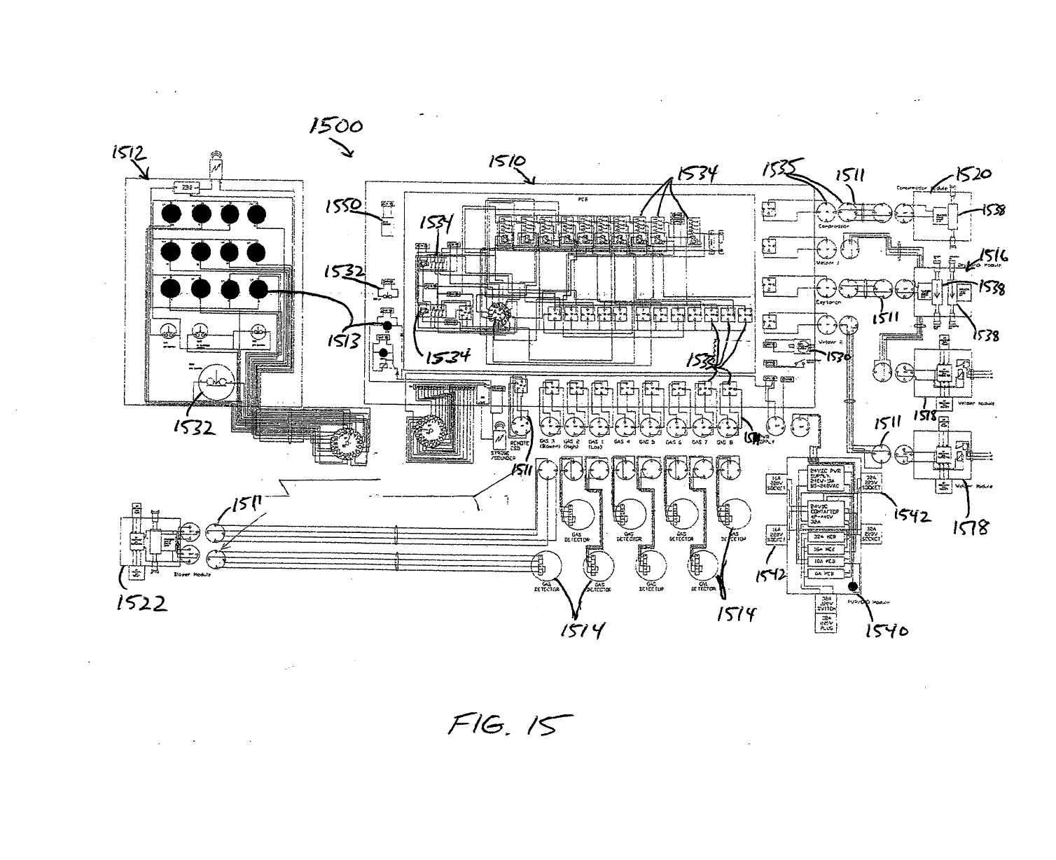

Turning now to FIG. 15, an exemplary embodiment explosion-proof (EX) rated zone shut-down control system is indicated generally by the reference numeral 1500. The system 1500 includes EX-rated components, including a field controller 1510, a plurality of multi-conductor cables 1511, at least one control panel 1512 connected to the field controller, a plurality of gas detectors 1514 connected to the field controller, a plurality of relays 1534 disposed in the field controller, each relay connected to a respective gas detector via at least one internal header or connector 1533 and at least one external connector 1535, a torch control module 1516 connected to the field controller, the torch control module having a plurality of gas solenoid valves 1538, at least one welder control module 1518 connected to the field controller, each welder control module having a contactor and a relay, a compressor control module 1520 connected to the field controller, the compressor control module having a gas solenoid valve, a plurality of emergency shutdown (ESD) switches 1532 connected to the field controller, a power and ground protected outlet (Power/GPO) control module 1540 connected to the field controller, the GPO control module having a plurality of power outlets 1542, such as 220 Volt, 32 Amp receptacles connected to a main or auxiliary relay. As described here, the system may be used for monitoring an open air zone and/or controlling an enclosure.

For use in an enclosure rather than in an unenclosed zone, a blower control module 1522 is further connected to the field controller, where the blower control module has a gas solenoid valve for controlling the introduction of fresh air into the enclosure and maintaining positive pressure. In addition, at least one differential pressure switch (DPS) 1530 is connected to the field controller in this configuration.

The control panel 1512 has at least one ESD switch 1532, an off switch, an on switch and a positive pressure override switch. The control panel also has a plurality of indicator lights 1513, including a green Gas 1 or Blower indicator, a green Gas 2 or Low placed gas detection indicator, a green Gas 3 or High placed gas detection indicator, a green Gas 4 gas detection indicator, a green Gas 5 gas detection indicator, a green Gas 6 gas detection indicator, a green Gas 7 gas detection indicator, a green Gas 8 gas detection indicator, a green ON indicator, a green Positive Pressure indicator, a yellow ESD indicator, and a red OFF indicator.

The system may further include a data logger 1550 connected to or incorporated in the field controller, an ESD switch mounted on the field controller, a yellow ESD indicator mounted on the field controller, and a green NORMAL indicator mounted on the field controller.

In this embodiment, the cables 1511 that connect to the field controller have male connectors, and the components such as gas detectors and equipment control modules have female sockets. The gas detectors may be given a designation when the system is used with an enclosure or habitat. In the non-pressurized mode, any gas detector can be used in any port. If less than eight detectors are used with the field controller of this embodiment in a non-pressurized mode, then one gas detector or dummy plug is connected to the blower port on the field controller.

That is, when the system is used as a shut-down control system in an enclosure or habitat, at least one gas detector is connected to the blower control module and placed in the airflow path into the blower. When the system is used in a non-pressurized monitoring mode, such gas detector may be connected directly to the field controller in places of the blower control module.

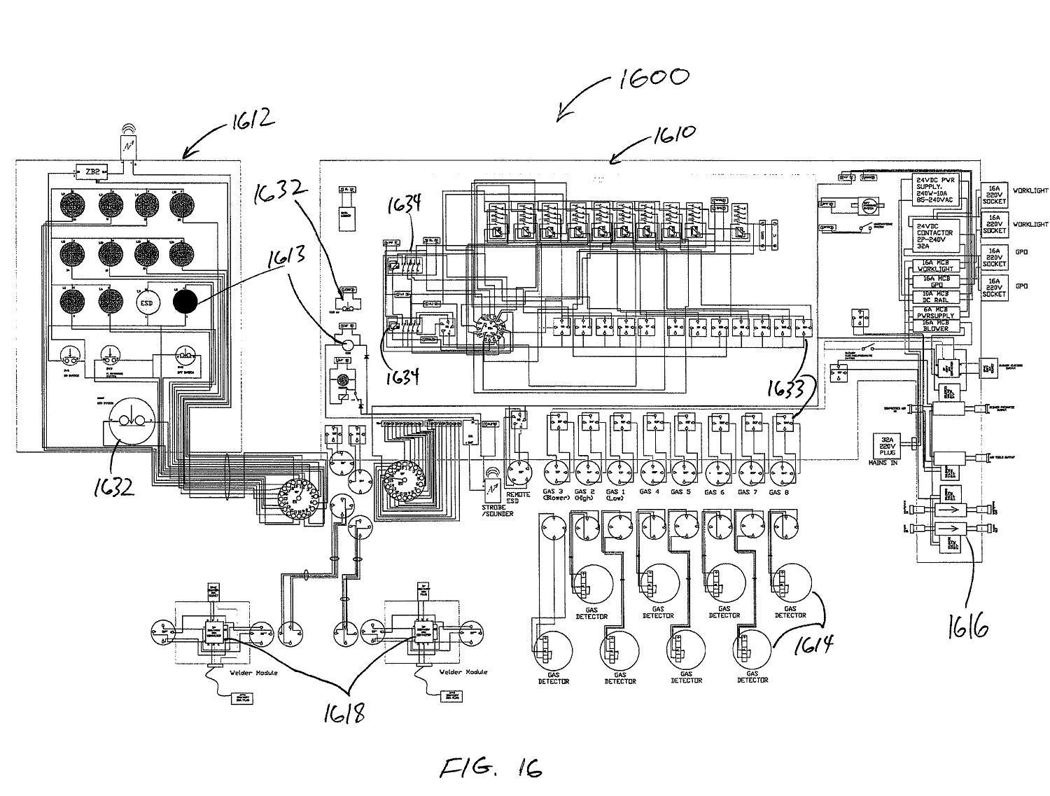

As shown in FIG. 16, an exemplary embodiment zone shut-down control system for welding is indicated generally by the reference numeral 1600. The system 1600 is similar to the system 1500 of FIG. 15, so duplicate description may be omitted. The system 1600 further includes an oxy-acetylene torch valve unit 1616 and at least one welding control unit 1618 connected to the field controller 1610.

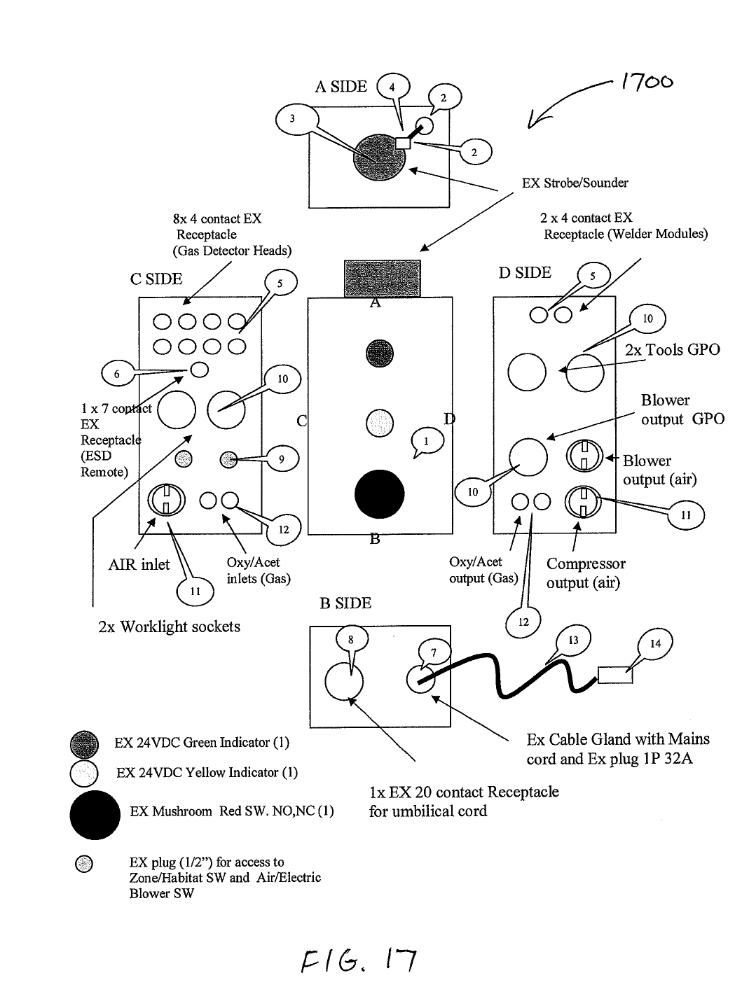

Turning to FIG. 17, an exemplary embodiment field control unit is indicated generally by the reference numeral 1700. The field control unit 1700 is similar to the field control unit 900 of FIG. 9, so duplicate description may be omitted. The field control unit includes a front face as described for FIG. 9, and four sides. The sides include an A side, a B side, a C side, and a D side. The A side includes an EX-rated strobe sounder 3. The B side includes an EX-rated cable gland 7 with mains cord 13 and EX-rated plug 1P−32 A 14, and an EX-rated 20-contact receptacle 8 for the umbilical cord.

The C side includes eight 4-contact EX-rated receptacles 5 suitable for gas detector heads, a 7-contact EX-rated receptacle 6 suitable for the ESD remote, two EX-rated ½″ plugs 9 for access to Zone/Habitat SW and Air/Electric Blower SW, respectively, two work-light sockets 10, an air inlet 11, and two gas inlets suitable for oxygen and acetylene, respectively. The D side includes two 4-contact EX-rated receptacles 5 suitable for welding modules, two GPO 10 for tools, a GPO 10 for blower output, an air output 11 for the blower, an air output 11 for air compressor tools, and two gas outputs 12 suitable for oxygen and acetylene.

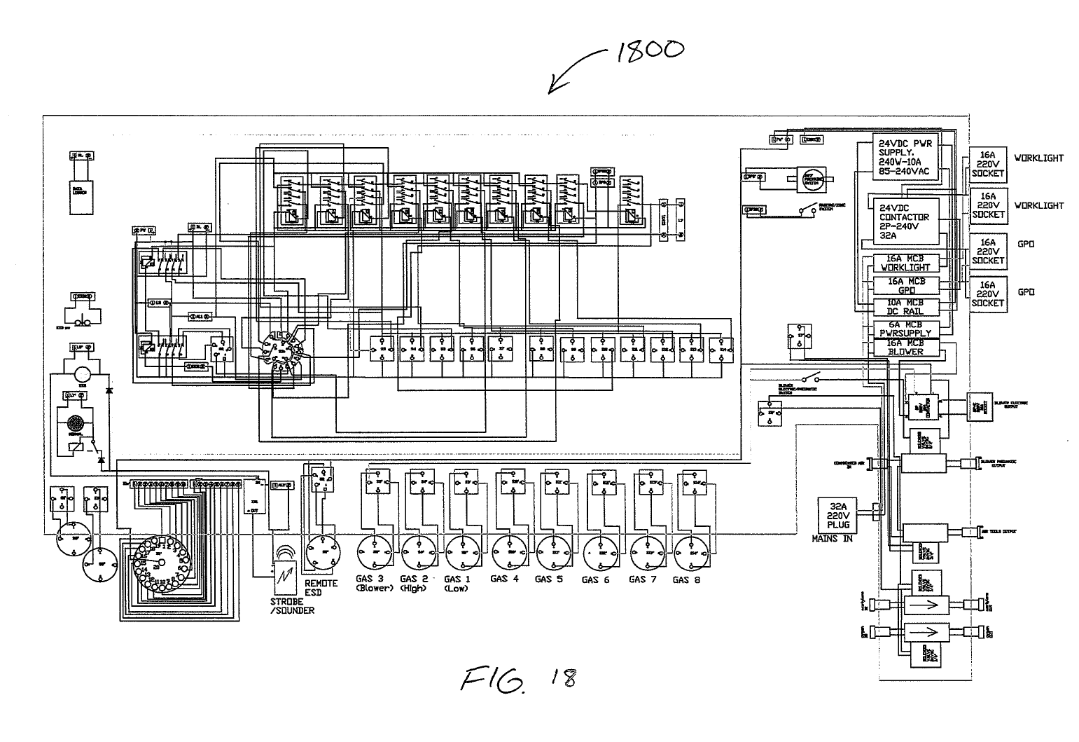

Turning now to FIG. 18, a schematic electrical diagram for the field control unit 1700 of FIG. 17 is indicated generally by the reference numeral 1800.

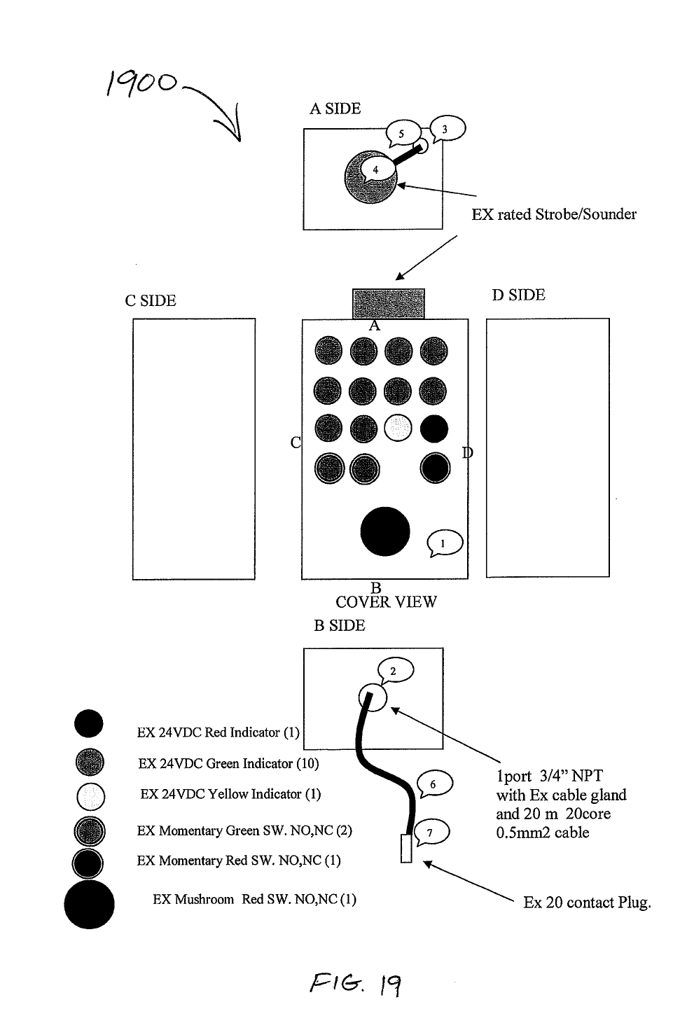

As shown in FIG. 19, an exemplary embodiment remote control unit is indicated generally by the reference numeral 1900. The remote control unit 1900 is similar to the remote control unit 800 of FIG. 8, so duplicate description may be omitted. The remote control unit includes a front face as described for FIG. 8, and four sides. The sides include an A side, a B side, a C side, and a D side. The A side includes an EX-rated strobe/sounder 5. The B side includes a one port ¾″ National Pipe Thread (NPT) fitting with EX-rated cable gland 2, 20 meters of 20 core 0.5 mm2 cable 6, and an EX-rated 20-contact plug 7.

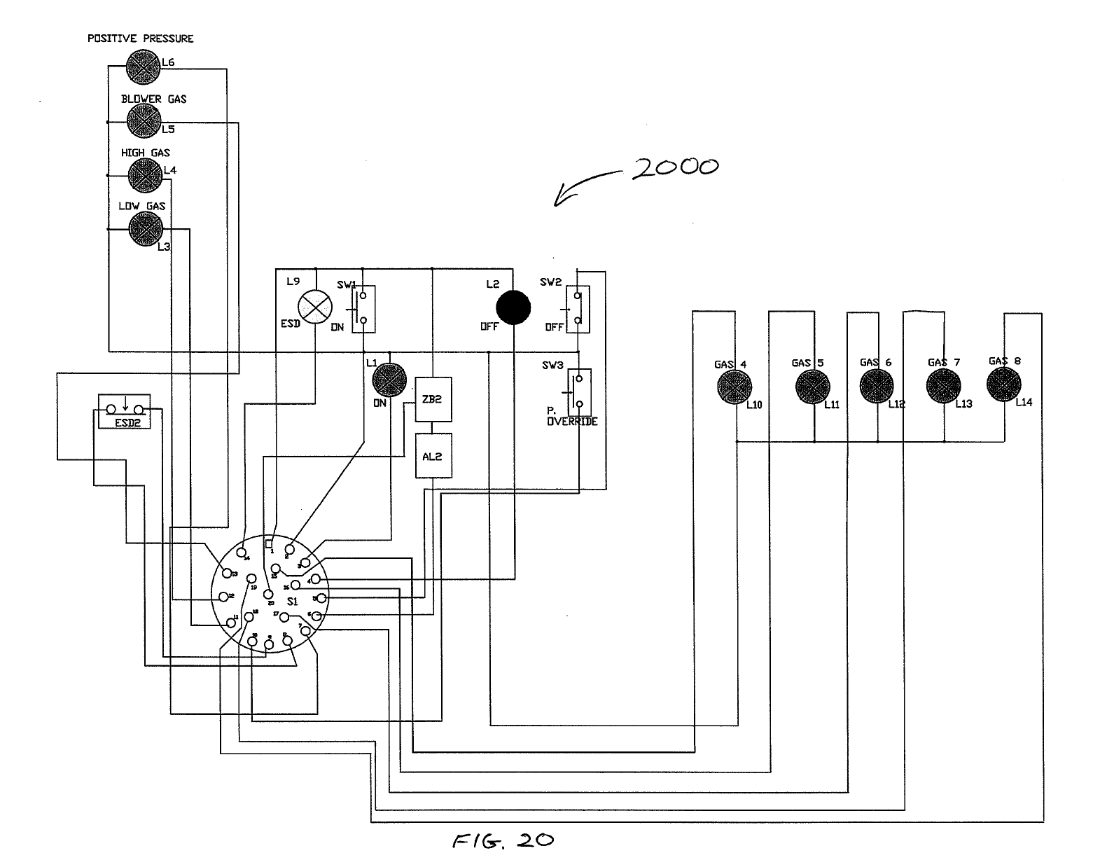

Turning to FIG. 20, a schematic electrical diagram remote for the control unit 1900 of FIG. 19 is indicated generally by the reference numeral 2000.

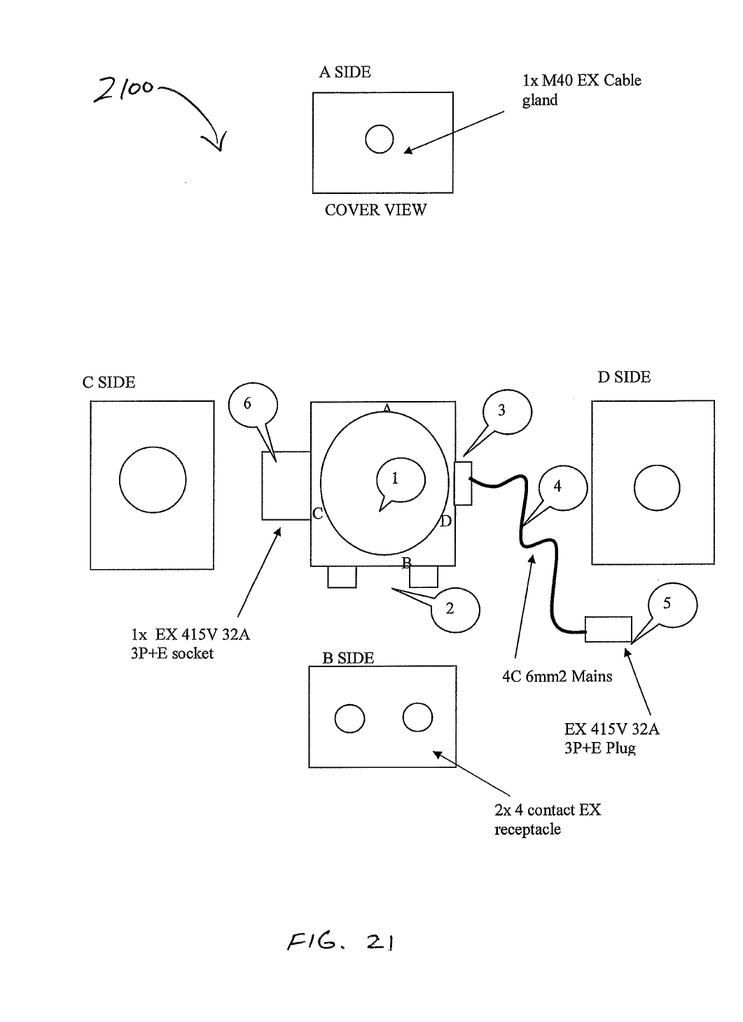

Turning now to FIG. 21, an exemplary embodiment welding control unit is indicated generally by the reference numeral 2100. The welding control unit 2100 is similar to the welding control unit 1200 of FIG. 12, so duplicate description may be omitted. The welding control unit 2100 includes a front face as described for FIG. 12, and four sides. The sides include an A side, a B side, a C side, and a D side. The A side includes an M40 EX-rated cable gland. The B side includes two 4-contact EX-rated receptacles 2. The C side includes an EX-rated 415V 32 A 3P+E electrical socket 6. The D side includes a 4-contact socket 3 connected to a 4 C 6 mm2 mains cable 4 and an EX-rated 415V 32 A 3P+E plug 5.

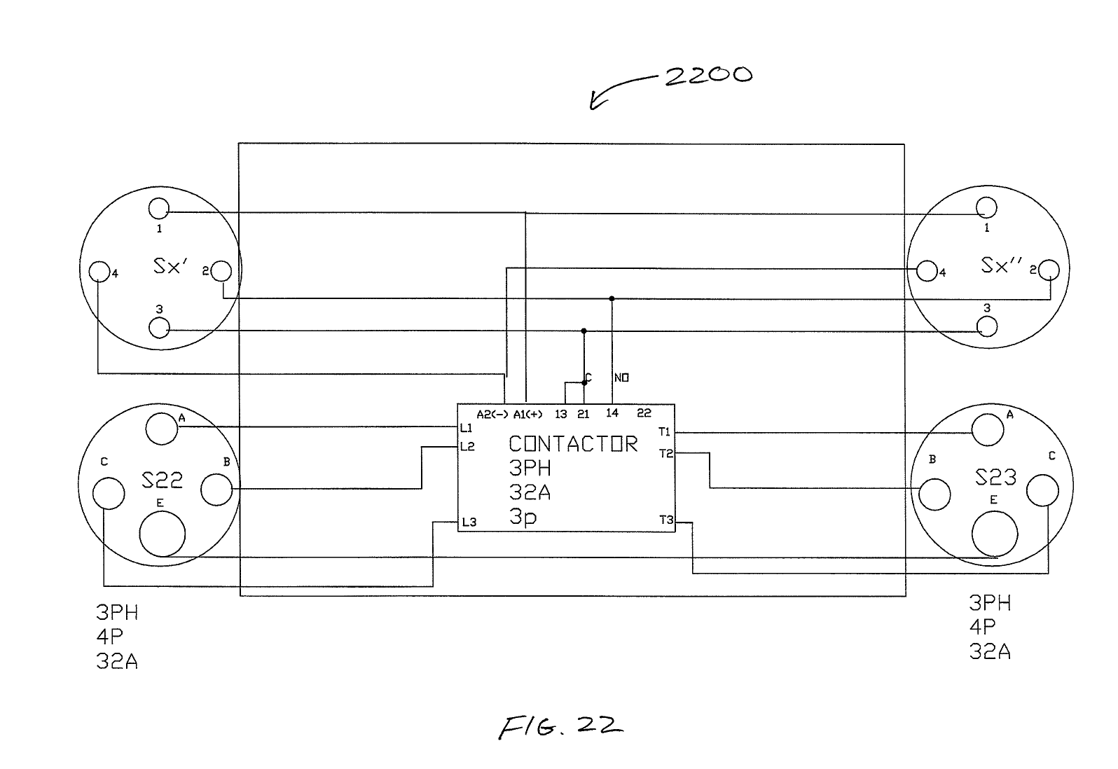

As shown in FIG. 22, a schematic electrical diagram remote for the welding control unit 2100 of FIG. 21 is indicated generally by the reference numeral 2200.

As described above, an exemplary embodiment system uses gas detectors in series with a differential pressure monitor unit to automatically detect hydrocarbons in the work area, and/or pressure lost in a pressurized enclosure. The systems are designed with intrinsically safe components to maximize safety margins within specifications, where applicable. The customized and simple nature of the systems allows them to be set up to work inside a pressurized hard or soft enclosure, in an open zone area or in an open air area to meet various needs.

If used within a pressurized enclosure, the exemplary embodiment system meets all current and anticipated performance standards, including CFR 250.803(b)(9)(i) for the control and management of air flow and pressures. In addition, the systems meet existing industry requirements of the United States Minerals Management Service (MMS), as well as Europe Health and Safety. Additional approvals and accreditations may follow.

The exemplary embodiment system is designed to meet industry requirements for work in class 1, division 1 and 2 areas. The system also incorporates a failsafe feature that allows it to monitor itself and shut down if an internal malfunction is detected, thereby eliminating another chance for human error.

While the currently disclosed exemplary embodiments may be suitable for a wide range of applications, alternate embodiment systems are contemplated in which the field controller may include one or more of a power source for hand tools such as two ground-fault protected outlets (2×GPO), remote control of all hot-work equipment, display of system status at all times, remote ESD and, interfacing to premises ESD if required, electric solenoid shut-off valves for torch gases, emergency back-up lighting, visual and audible alarm system, and/or work lights.

Exemplary embodiment systems are designed to automatically monitor the atmosphere in and around hot work areas where a combustible atmosphere may exist. This may be done by using one to eight gas detectors connected in series, and a differential pressure switch (DPS) if used in a pressurized environment. The system will continually monitor the atmosphere during the hot work and will automatically shut down all equipment associated with the hot work operation in the event of a gas detector alarm or loss of pressure. This is done by using inline electric solenoids and relays controlled by a field control unit.

The systems incorporate relay logic, where the electrical relays are normally open and the electrical solenoids are normally closed so they will fail safe. The system controls are on site of the work being done, and the control panel is explosion proof (EX) rated so it can operate in a classified area. Moreover, the systems do not rely on any computer software to operate.

If an enclosure is constructed, and positive pressure is introduced into it, the environment inside the enclosure will remain free from hazardous gases that could ignite. In conjunction with the Enclosure, an automatic shut-down system is useful to shut down the hot-work equipment automatically if hydrocarbons are detected, if there is a pressure loss in the enclosure or a remote hot work ESD is activated. This combination of an enclosure built around the area where hot-work is to be performed and the installation of an automatic Shut-down System assures that production platform/facilities can remain safely operational during hot-work operations. Thus, lost revenue due to shut-ins on production platforms/facilities can be limited if not completely eliminated.

Soft-sided enclosures are made from a fire retardant fabric that is installed in sections by straps, zippers and hook and loop fasteners (e.g., Velcro™), for example. The characteristics of a soft-sided enclosure include that it is cost efficient, light weight, easy to construct and remove, provides spark containment, holds positive pressure, introduces ventilation from a fresh air source, provides a weather controlled environment, meets existing regulatory requirements, and creates peace of mind for the workers and management. A soft-sided enclosure is useful whenever hot-work is to be performed in an area where there is a danger of hydrocarbons reaching an ignition source, or where spark containment is of special concern.

Hard-sided enclosures are made from fire retardant wood and sealed with fireproof caulk and tape. The floor has added protection by using a combination of a fire retardant fabric and a thin layer of stainless steel sheeting. However, this Enclosure can be made of any fire retardant hard material, as long as positive pressure can be maintained inside. The characteristics of a hard-sided enclosure include that it provides spark containment, holds positive pressure, takes longer to construct and remove than soft-sided enclosure, may cost more than a soft-sided enclosure, meets existing regulatory requirements, provides a weather controlled environment, introduces ventilation from a fresh air source, creates piece of mind for the workers and management, and provides greater protection from heavy sparks and slag. A hard-sided enclosure is useful whenever hot-work is to be performed in an area where there is a danger of hydrocarbons reaching an ignition source.

A feature of the zone shut-down control system is to detect and automatically shut down all hot-work equipment in the event that hydrocarbons or toxic gases are detected, pressure is lost, or an emergency shut-down switch is activated. A zone shut-down system is useful whenever hot-work is to be performed in a designated classified area, within three meters of operating process equipment, within 15 meters of stored hydrocarbon products, and/or downwind of equipment with the potential to spontaneously release hydrocarbons or spark containment is of special concern.

A zone shut-down control system of the present disclosure, when combined with an enclosure, permits hot-work to be performed in classified areas on operating production platforms and facilities both on-shore and off-shore, provides a cost effective solution to prevent facility shut-downs while performing hot-work operations on operating oil or gas facilities, reduces or eliminates the possibility of the production platform igniting, incorporates a fail-safe system that not only detects hydrocarbons and/or pressure lost, but will also shut down hot-work equipment in the event that there is a malfunction in the system itself, eliminates the possibility of human error in detecting hydrocarbons and/or pressure loss and shutting down hot-work operations without due cause, meets all existing regulatory requirements, and is designed for use in class 1, division 1 and 2 areas.

In addition, an exemplary embodiment zone shut-down control system of the present disclosure provides a weather controlled environment for workers inside an enclosure, provides accurate data for the environment inside the enclosure during hot-work operations, is easy to transport and store uses parts that can easily be sourced and replaced, can operate with a soft or hard-sided enclosure, allows for fast installation and dismantling, and can be used to monitor an enclosure, an open zone area or an open air area.

The system is reconfigurable to fulfill at least three different needs. First, for pressurized enclosure shut-down applications, it performs continuous monitoring of atmospheric conditions inside an enclosure, only allows hot work to take place if positive pressure is maintained, and has an integrated shut down capability of all associated hot-work components. Second, for non-pressurized shut-down applications without an enclosure, it performs continuous monitoring of atmospheric conditions around a hot-work area, creates a safe zone around uncontained, open air welding scenarios, and provides integrated shut down capability of all associated hot-work components. Third, for an area atmospheric monitoring application without an enclosure, the system may conduct continuous monitoring of atmospheric conditions without being integrated with the shut down capability of any hot-work components. Here, applications may include vessel or confined space entry, hydrogen sulfide (H2S) monitoring, and/or hydrocarbon monitoring.

These and other features of the present disclosure may be readily ascertained by one of ordinary skill in the pertinent art based on the teachings herein. Although illustrative embodiments have been described herein with reference to the accompanying drawings, it is to be understood that the present disclosure is not limited to those precise embodiments, and that various other changes and modifications may be effected therein by those of ordinary skill in the pertinent art without departing from the scope or spirit of the present disclosure. All such changes and modifications are intended to be included within the scope of the present disclosure as set forth in the appended claims.

What is claimed is:

1. A reconfigurable zone shut-down control system usable in an enclosure, the system comprising:
a field controller disposed within the enclosure;
a control panel electrically connected to the field controller;
a differential pressure switch electrically connected to the field controller;
a plurality of gas detectors electrically connected to the field controller; and
a plurality of device controllers electrically connected to the field controller,
wherein the plurality of device controllers includes at least one of a fresh air blower controller, a welding machine controller, an air compressor controller, or a gas torch controller.

2. The system of claim 1 wherein the field controller is disposed to shut down all devices connected to the plurality of device controllers in accordance with a signal from the control panel.

3. The system of claim 1 wherein the field controller is disposed to shut down at least one device connected to the plurality of device controllers if the differential pressure switch fails to detect a positive pressure differential inside the enclosure versus outside.

4. The system of claim 3 wherein the field controller is disposed to simultaneously shut down a plurality of devices connected to the plurality of device controllers if the differential pressure switch fails to detect a positive pressure differential inside the enclosure versus outside.

5. The system of claim 3 wherein the field controller is disposed to sequentially shut down in a pre-defined order a plurality of devices connected to the plurality of device controllers if the differential pressure switch fails to detect a positive pressure differential inside the enclosure versus outside.

6. The system of claim 1, further comprising:
an external fresh air blower connected to the fresh air blower controller; and
an external gas detector disposed in the air intake path of the fresh air blower and connected to the fresh air blower controller,
wherein the field controller is configured to shut down at least one device if the external gas detector detects at least one of a toxic or flammable gas.

7. The system of claim 1 wherein the control panel is disposed on a wall of the enclosure, and all system components are explosion-proof (EX) rated.

8. The system of claim 1 wherein at least one source of flammable gas is disposed outside of the enclosure.

9. A zone shut-down control system usable in an enclosure, the system comprising:
field control means disposable within the enclosure;
input/output means connected to the control means;
differential pressure means connected to the control means;
gas detection means connected to the control means; and
device control means connected to the field control means, wherein the device control means includes at least one of fresh air blower control means, welding machine control means, air compressor control means, or gas torch control means.

10. The system of claim 9 wherein the field control means is disposed to shut down all devices connected to the plurality of device control means in accordance with a signal from the input/output means.

11. The system of claim 9 wherein the field control means is disposed to shut down at least one device connected to the device control means if the differential pressure means fails to detect a positive pressure differential inside the enclosure versus outside.

12. The system of claim 9 wherein the field control means is disposed to simultaneously shut down a plurality of devices connected to the device control means if the differential pressure means fails to detect a positive pressure differential inside the enclosure versus outside.

13. The system of claim 9 wherein the field control means is disposed to sequentially shut down in a pre-defined order a plurality of devices connected to the device control means if the differential pressure means fails to detect a positive pressure differential inside the enclosure versus outside.

14. The system of claim 9, further comprising:
an external fresh air blower connected to the fresh air blower control means; and
an external gas detector disposed in the air intake path of the fresh air blower and connected to the fresh air blower control means,
wherein the field control means is configured to shut down at least one device if the external gas detector detects at least one of a toxic or flammable gas.

15. A method of area monitoring and control comprising:
sensing flammable and toxic gas contaminants in air;
if flammable or toxic gas contaminants are sensed, signaling an alarm;
if flammable or toxic gas contaminants are not sensed, passing electrical power and gas to equipment within the zone; and
if an emergency shutdown switch is activated in the zone, preventing power and gas from reaching equipment within the enclosure.

16. The method of claim 15 wherein the equipment includes electrical and gas tools comprising at least one of a fresh air blower, a welding machine, an air compressor, or a gas torch.

17. The method of claim 15, said contaminants comprising at least two of hydrocarbons, oxygen, or toxic gas.

18. The method of claim 15 wherein at least one source of flammable gas is disposed outside of the zone.

19. The method of claim 15 wherein the zone is a temporary enclosure, the method further comprising:
sensing flammable or toxic gas contaminants in intake air;
if no contaminants are sensed, blowing the intake air into the enclosure;
sensing flammable or toxic gas contaminants in the enclosure; and
if no contaminants are sensed, providing power and gas to equipment within the enclosure.

20. The method of claim 19, further comprising:
sensing a positive pressure differential between air inside the enclosure relative to air outside the enclosure; and
if a positive pressure differential is not sensed, performing a shutdown of electrical and gas equipment within the enclosure.
